(19) United States
(12) Patent Application Publication
(10) Pub. No.: US 2022/0379149 A1
(43) Pub. Date: Dec. 1, 2022

(54) SYSTEM AND METHOD FOR LIMITING SPREAD OF WILDFIRE

(71) Applicant: Hugnora Invest och Tjänsteproduktion AB, Täby (SE)

(72) Inventors: Lennart Nordlund, Stockholm (SE); Johan Danielsson, Solna (SE); Jan Ohlsson, Täby (SE)

(21) Appl. No.: 17/774,979

(22) PCT Filed: Nov. 6, 2020
(86) PCT No.: PCT/SE2020/051074

§ 371 Date: May 6, 2022

(30) Foreign Application Priority Data
Nov. 8, 2019 (SE) 1951278-9

(51) Int. Cl. A62C 3/02

(52) U.S. Cl. CPC A62C 3/0207; A62C 3/0264

(57) ABSTRACT

The document relates to a method for limiting the spread of a wildfire, comprising: defining a fire limiting boundary (4); positioning a plurality of droplet generating units (1) along the fire limiting boundary (4); connecting said droplet generating units (1) to a liquid source (3); and activating said droplet generating units (1) so that a mist is applied to a border area (41) along said fire limiting boundary (4), said border area (41) having a width, as seen in a direction across the fire limiting boundary, which is 20-200 m, preferably 50-150 m, wherein said actuation of said droplet generating units (1) being initiated before the wildfire (5) is at least 500 m, preferably at least 1000 m, at least 2000 m, at least 5000 m, or at least 10,000 meters, from fire limiting boundary (4). Each droplet generating unit (1) provides a mist throw length (L) of 20-200 m, preferably 20-30 m, 30-40 m, 40-50 m, 50-60 m, 60-70 m, 70-80 m, 80-90 m, 90-100 m, 100-120 m, 120-140 m, 140-160 m or 160-180 m, and each droplet generator (10) operates in an angled position relative to the frame (11) at an angle of 10-60 degrees seen to a horizontal plane, preferably at an angle of 20-50 degrees seen to a horizontal plane.

### TECHNICAL FIELD

The present invention relates to a system and a method for preventing the spread of wildfires.

### BACKGROUND

Fighting and preventing the spread of wildfires has been and is a widespread problem in several parts of the world. Uncontrollable wildfires are in many ways a threat to both humans and nature, both in the form of ecological and socio-economic damage, but also in form of negative health effects. Wildfires also cause large CO₂-emissions which have a negative climate impact.

With the effects seen as a result of climate change and a warmer and drier climate, wildfires are perceived as an increasing threat. A risk that is often discussed in connection with climate change is that wildfires both will increase in number and size in the future as a result of climate change.

To prevent the spread of fires, there are several different known techniques.

Firebreaks can, for example, be built to prevent the spread of a wildfire. Such firebreaks can be created by burning off an area, which prevents spreading in such a way that the area cannot burn again since the fuel is already consumed. Furthermore, construction of these firebreaks can also include digging ditches and/or felling trees in a wide band to reduce the risk of spreading crown fires and spot fires, i.e. that the fire jumps between the treetops. This requires extensive intervention in nature.

A simpler intervention in form of a handmade firebreak, which is constructed by means of hand equipment, can be effective if the intensity of the fire front, i.e. the frontal and most difficult part of the wildfire to extinguish, is calm (<345 kW/m) and the flame length is less than 1 meter. If the intensity of the fire front on the other hand, is rather high or larger (>345 kW/m) and the flame length is larger than 1 meter, a handmade firebreak cannot be considered reliable. Equipment such as harvesters, excavators, etc. may then be required and construction of the firebreaks can be relatively time consuming in mostly time-pressured situations and creates great damage in nature.

A known method is also to blast firebreaks, which can be faster and reduce damage to nature, compared to other methods. Construction of all types of firebreaks, however, involves intervention and impact on nature.

Furthermore, the work of constructing firebreaks is physical staff-intensive, which further poses a challenge in many cases.

Additional known technology to fight wildfires and prevent spread includes attacks with flying units, for example by means of so-called water bombing. However, such technology is very costly and is limited in terms of accuracy.

Furthermore, it is known to use water mist to prevent spread of fires. U.S. Pat. No. 5,931,233 discloses a method for preventing the spread of fires, by arranging a number of droplet generators along one property boundary. The mist generators are oriented vertically, with the purpose of offering a dome of cooled air over and around the property, so as to protect the property from a wildfire that is about to spread to the property area. However, the system as shown in U.S. Pat. No. 5,931,233 is very much depending on environmental factors and conditions, such as wind conditions.

Another challenge regarding the work of preventing spread of wildfires is to ensure minimal risk for the people who work in fighting and preventing the spread of wildfires. The work involves several different security risks, for example in areas including power lines, which require certain protective measures to be taken and the work may be further complicated.

Thus, there is a need for an improved and more efficient fire prevention system and method. It is desirable to be able to quickly create an effective fire protection moisture barrier that does not harm nature. It is also desirable that the system and method also minimize safety risks and streamline the work for those who work to prevent the spread of the fire.

### SUMMARY

Thus, an object of the present invention is to provide an improved and more effective fire prevention system and method that solves at least some of the problems described above.

More specifically, an object of the present invention is to provide a system and method that can be used to create a more effective fire limiting boundary, which can be used to prevent a wildfire from spreading to a protected country estate or property, or to surround a wildfire and thus prevent the spread of the fire.

The invention is defined by the appended independent claims. Embodiments appear from the dependent claims, from the following description and drawings.

According to a first aspect, there is provided a method for limiting spreading of a wildfire, comprising: defining a fire limiting boundary; to position a plurality of droplet generating units along the fire limiting boundary; to connect said droplet generating units to a liquid source; and activating said droplet generating units so as to apply mist to a border area along said fire limiting boundary, wherein said border area has a width, as seen in a direction transversal to the fire limiting boundary, which is 20-200 m, preferably 50-150 m, and wherein said actuation of said droplet generating units being initiated before the wildfire being at least 500 m, preferably at least 1000 m, at least 2000 m, at least 5000 m, or at least 10 000 meters, from the fire limiting boundary.

Each of the droplet generating units comprises a frame, and one fan driven droplet generator attached to the frame, wherein the fan driven droplet generator comprises: a fan for drawing air into the fan driven droplet generator; a discharge tube for creating a high velocity air flow, wherein the discharge tube has a distal end; and a plurality of nozzles that are operatively connected to the liquid source, and which are arranged proximally to the distal end of the discharging tube to create a plurality of liquid droplets to form a mist, wherein each droplet generating unit provides a mist throw length of 20-200 m, preferably 20-30 m, 30-40 m, 40-50 m, 50-60 m, 60-70 m, 70-80 m, 80-90 m, 90-100 m, 100-120 m, 120-140 m, 140-160 mor 160-180 m, and wherein each droplet generator operates in an angled position relative to the frame at an angle of 10-60 degrees seen to a horizontal plane, preferably at an angle of 20-50 degrees seen to a horizontal plane.

The liquid source has as a purpose to provide liquid to the fan driven droplet generator and may be different types of liquid sources. The liquid source can be a naturally occurring liquid source, i.e. a liquid source that is not temporarily provided solely for firefighting. The liquid source may, for example, comprise at least one of the following: a sea, a lake, a watercourse, a river, a pond, and/or an open water reservoir.

Alternatively, the liquid source may be a liquid source temporarily arranged for firefighting, for example in form of a fire pond.

The liquid can be led from the liquid source to the droplet generating unit via one or more liquid lines.

A pump can be used to pump liquid from the liquid source to the droplet generating unit via said one or more liquid lines.

Thus, the liquid source can be separated from the mist generating unit and connected to the mist generating unit via a hose.

The droplet generating unit can be supplied with liquid by connection to a fire hydrant.

At least some of said droplet generating units may be connected to the same liquid source. Alternatively, at least some of the above droplet generating units may be connected to different liquid sources.

The fan driven droplet generator can be designed as a type of cannon.

The frame of each droplet generating unit can be grounded, i.e. be arranged to be placed directly on the ground when using the system.

Furthermore, a power source can be arranged to supply the plurality of droplet generating units with energy. A line can for instance be arranged which connects the fan to the power source to drive the fan.

Said droplet generating units, positioned along the fire limiting boundary can provide the same throw length or different throw lengths. For example, some of said droplet generating units may provide a first throw length and some other of said droplet generating units may provide a second throw length, wherein the first and second throw lengths differ from each other.

Furthermore, said droplet generating units can operate at the same angle seen to a horizontal plane, alternatively at different angles seen to a horizontal plane. For example, some of said droplet generating units may operate at a first angle seen to a horizontal plane and some others of said droplet generating units may operate at a second angle, wherein the first and second angles are different from each other.

The method as described above makes it possible to quickly be able to provide an effective fire protection barrier.

The droplet generating units can be connected to natural water sources and are easy to place out. Thereby, they can be quickly placed directly on the ground along a desired fire limiting boundary line.

The method also makes it possible to shoot mist far sideways. By the method, mist can be applied over an area in a controlled and directed manner. The method according to the above can thus be used to create an increased moisture content in the forest fuel (trees, shrubs, mosses, lichens, grass and other vegetation) in a controlled manner.

The increased moisture content makes the forest fuel difficult to catch fire. Thus, an effective fire protection barrier is created.

By the method as described above, mist can be applied over an area, wherein the forest fuel in the area may obtain an average moisture ratio of at least 10%, preferably at least 15% or at least 20%, or more preferably at least 25%.

The forest fuel in the area can obtain an average moisture ratio of 10-50%, preferably 15-40%, 15-35%, 20-30%, 20-25% or 25-30%.

The average moisture ratio of the forest fuel within an area, is defined as the amount of water per cubic meter of solid material within the area.

The method can thereby build up an effective fire protection zone, without being dependent on surrounding factors and conditions such as wind conditions.

The method as described above also allows efficient use of water resources, less damage on nature, requires less staff compared to traditional methods such as construction of firebreaks, and means less physical strain and less safety risks for those who work with preventing the spread of the fire.

The method as described above thus provides both advantages in terms of resource efficiency and cost efficiency compared to previous prior art for limiting the spread of wildfires.

Each droplet generator can operate to provide an air volume flow of 5-60 m³/s, preferably 5-50 m³/s, 5-40 m³/s, 5-30 m³/s, 6-25 m³/s, 6-20 m³/s, 6-15 m³/s or 7-10 m³/s.

Each droplet generator, when in operation, can consume water at a rate of 20-100 l/min, preferably 30-90 l/min or 30-70 l/min.

At least some of said droplet generators, when in operation, can operate with a pressure of the nozzles at 70 bar.

At least 70% of a water volume supplied to the droplet generating unit from the liquid source can be applied to a fire limiting area extending over a distance, as seen in a direction perpendicular to said fire limiting boundary, corresponding to 50-80% of the throw length of the droplet generating unit, preferably at least 55% of the throw length of the droplet generating unit.

The fire limiting area can be located within the border area.

Through the method as described above, the forest fuel within the fire protection area can obtain an average moisture ratio of at least 10%, preferably at least 15% or at least 20%, or more preferably at least 25%.

The forest fuel within the fire limiting area can obtain an average moisture ratio of 10-50%, preferably 15-40%, 15-35%, 20-30%, 20-25% or 25-30%.

The average moisture ratio for forest fuel within the fire limiting area is defined as the amount of water per cubic meter of solid material within the fire limiting area.

Said actuation of said droplet generating units can be initiated when a wildfire is at least 3 hours away, or preferably at least 5 hours away, given an expected rate of spread of said wildfire (5).

Distance to a wildfire is defined as a distance from the fire limiting boundary to the fire front of the wildfire, i.e. the front and part of the wildfire most difficult to extinguish.

An average moisture ratio of a forest fuel within the fire limiting area may be at least 25% measured at a time 5 hours after said actuation of said droplet generating units is initiated, preferably measured at a time 3 hours after said actuation of said droplet generating units is initiated.

By “forest fuel” is meant all vegetation and materials that can serve as fuel for the fire, such as trees, shrubs, mosses, lichens, grass and other vegetation.

The step of defining a fire limiting boundary may include to identify a position for a wildfire, wherein the fire limiting boundary is defined based on said position.

The step of positioning a plurality of mist generating units along the fire limiting boundary may comprise moving the mist generating units from at least one central supply location, which accommodates at least some of said plurality of mist generating units, to positions along the fire limiting boundary.

The mist generating units can be moved by means of a transport vehicle and unloaded from the transport vehicle at the respective mentioned position.

One or more mist generating units can, for example, be placed along said fire limiting boundary by means of a quad bike or other transport vehicle which is preferably adapted for driving in terrain.

The method according to the above is thereby less labor intensive and puts less physical strain on staff compared to existing methods for limiting wildfires, as the focus of the work shifts from the construction of firebrakes, direct firefighting, etc. to instead include the deployment of the mist generating units and control of the mist generating units.

Said fire limiting boundary can be defined as an elongated line extending over a length of more than 300 m, preferably more than 1000 m, or more than 5000 m.

The fire limiting boundary can extend along a forest road or a powerline corridor.

Said fire limiting boundary can be defined by the fact that it extends along at least part of a property boundary.

At least two droplet generating units can be positioned per 100 m of a length of said fire limiting boundary.

Each fan driven droplet generator can produce liquid droplets having an average size of 5-180 micrometers, preferably 10-150 micrometers 10-50 micrometers, 50-100 micrometers, about 25 micrometers or about 70 micrometers.

At least some of said droplet generators can be actuated to rotate relative the frame about a vertical axis.

The rotation can be 300-360 degrees or 90-180 degrees.

The rotation can be driven.

At least some of said droplet generators can be actuated to operate with an oscillating motion.

At least some of said droplet generating units can be actuated to operate with a first type of spray pattern for a first time period, and with a second type of spray pattern during a second time period.

The starting point for the first time period is defined as the time when said actuation of said droplet generating units is initiated. The end point of the first time period is defined as the time when the droplet generating units are actuated to switch to a second type of spray pattern. Thus, the end time of the first time period may coincide with a start time of the second time period.

Alternatively, at least some of said droplet generating units may be actuated to operate alternately between at least two different types of spray patterns.

According to a second aspect, there is provided a system for limiting the spreading of wildfires, comprising: a plurality of droplet generating units, positioned along a fire limiting boundary, and a liquid source, wherein each droplet generating unit includes a frame, and a fan driven droplet generator attached to the frame.

The fan driven droplet generator comprises: a fan for drawing air into the fan driven droplet generator; a discharge tube to create a high velocity air flow, wherein the discharge tube has a distal end; and a plurality of nozzles operatively connected to the liquid source, and which are arranged proximally to the distal end of the discharge tube to create a plurality of liquid droplets to form a mist.

Each droplet generating unit is configured to provide a mist throw length (L) of 20-200 m, preferably 20-30 m, 30-40 m, 40-50 m, 50-60 m, 60-70 m, 70-80 m, 80-90 m, 90-100 m, 100-120 m, 120-140 m, 140-160 m or 160-180 m, and

Each droplet generator is angular adjustable relative to the frame at an angle of 10-60 degrees seen to a horizontal plane, preferably 20-50 degrees seen to a horizontal plane.

Each droplet generator can be configured to provide an air volume flow of 5-60 m³/s, preferably 5-50 m³/s, 5-40 m³/s, 5-30 m³/s, 6-25 m³/s, 6-20 m³/s, 6-15 m³/s or 7-10 m³/s.

The liquid source can be separate from the mist generating unit and connected to the mist generating unit via a hose.

A hose length of the hose can be at least 10 m, preferably at least 20 m.

The liquid source may comprise at least one of the following: a sea, a lake, a watercourse, a river, a pond, and/or an open water reservoir.

Each droplet generating unit may further comprise an angle actuator, wherein the angle actuator is configured to angle the droplet generator at an angle of 10-60 degrees seen to a horizontal plane, preferably 20-50 degrees seen to a horizontal plane.

Each droplet generator may be configured to consume water at a rate of 20-100 l/min, preferably 30-90 l/min or 30-70 l/min.

At least some of said droplet generators may be configured to operate with a pressure of the nozzles at 70 bar.

At least some of said droplet generating units may be configured to apply at least 70% of a water volume supplied to the droplet generating unit from the liquid source during operation, to a fire limiting area extending over a distance, seen in a direction perpendicular to said fire limiting boundary, corresponding to 50-80% of the throw length of the droplet generating unit, preferably at least 55% of the throw length of the droplet generating unit.

Said frame can support a single mist generator and has feet and/or pivot wheels for placement on the ground.

The system may include at least two droplet generating units per 100 m of a length of the fire limiting boundary.

Each droplet generator may be configured to discharge a mist at an angle of 10-60 degrees, preferably 20-50 degrees, relative to a horizontal plane.

Each fan driven droplet generator may be configured to provide liquid droplets having an average size of 5-180 micrometers in diameter, preferably 10-150 micrometers, 10-50 micrometers, 50-100 micrometers, about 25 micrometers or about 70 micrometers in diameter.

At least some of said droplet generating units may comprise a pivotable attachment portion, whereby the droplet generator is rotatable relative to the frame about a vertical axis.

At least some of said droplet generating unit may further comprise a rotation actuator, wherein the rotation actuator is configured to rotate the droplet generator relative to the frame about a vertical axis.

According to a third aspect, there is provided use of a system as described above for preventing the spread of a wildfire, wherein the mist generating units are placed along a fire limiting boundary after a wildfire has been identified.

### BRIEF DESCRIPTION OF THE DRAWINGS

FIG. 1 schematically shows a droplet generating unit 1.

FIGS. 2a-2c schematically show spray pattern of the droplet generating units.

FIG. 3 schematically shows an elongated fire limiting boundary.

FIG. 4 schematically shows a fire limiting boundary which extends partly around a property.

FIG. 5 schematically shows a droplet generating unit which generates a moisture increase of a forest fuel over a border area comprising a fire limiting area.

FIGS. 6a-6c schematically show a droplet generating unit with varying spray patterns.

FIG. 7 schematically shows a first example of how the amount of water supplied can be distributed over an area given a certain throw length.

FIG. 8 schematically shows a second example of how the amount of water supplied can be distributed over an area given a certain throw length.

### DETAILED DESCRIPTION

The invention relates to a system for limiting the spread of wildfires, wherein the system comprises a plurality of droplet generating units 1 positioned along a fire limiting boundary 4.

The droplet generating units are arranged to increase a moisture content of a forest fuel over a border area 41 comprising a fire limiting area 42. The increase in moisture content of the forest fuel can last hour after hour.

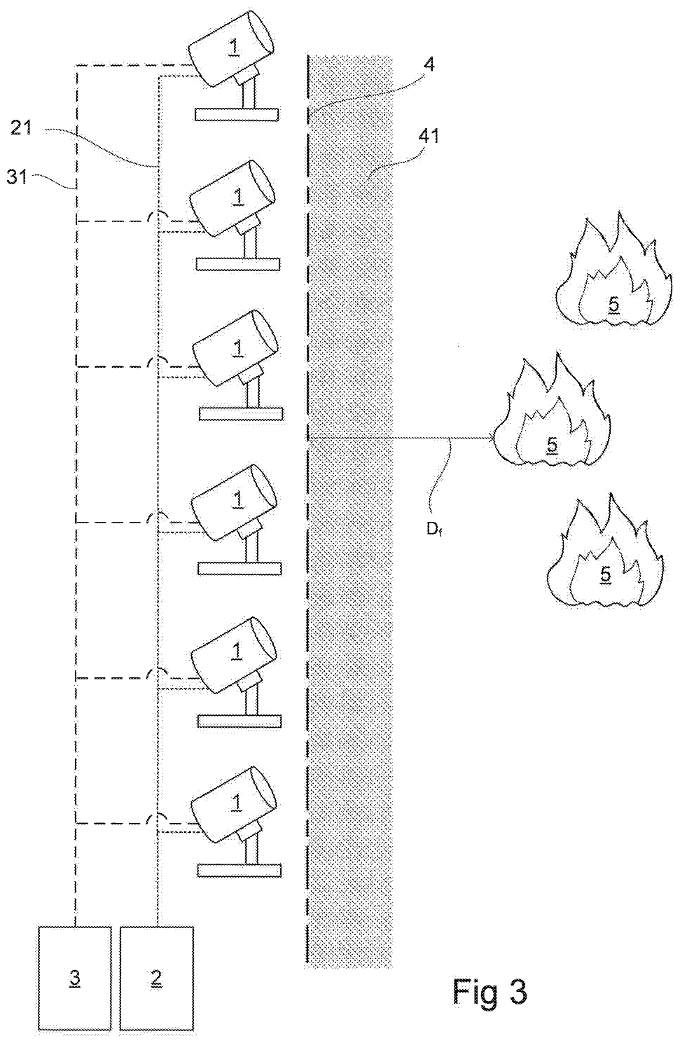

The fire limiting boundary 4 can be an elongated fire limiting boundary, see for example FIG. 3.

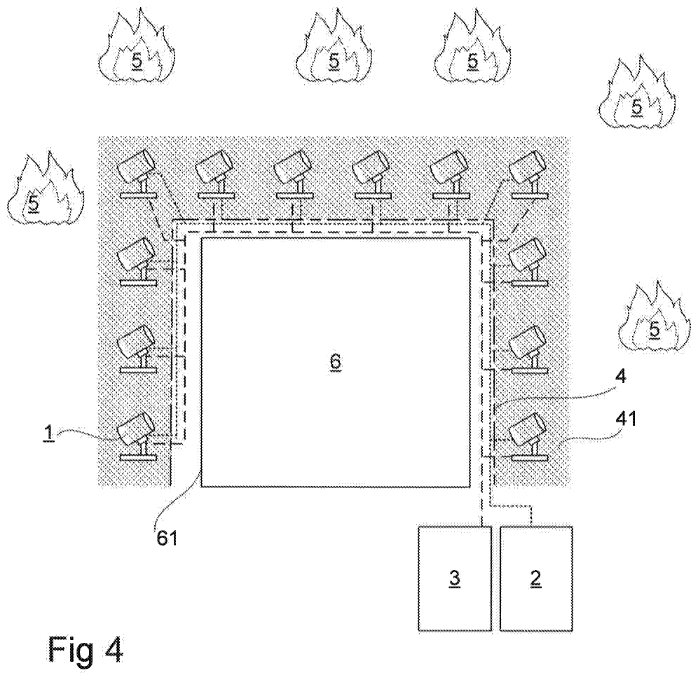

In addition or alternatively, the fire limiting boundary 4 can be a fire limiting boundary which extends at least partially around a property 6, see FIG. 4.

In addition or alternatively, said fire limiting boundary 4 may extend along a forest road or a powerline corridor (not shown).

The system further comprises a liquid source 3.

The system may comprise at least two droplet generating units 1 per 100 m of a length of the fire limiting boundary 4.

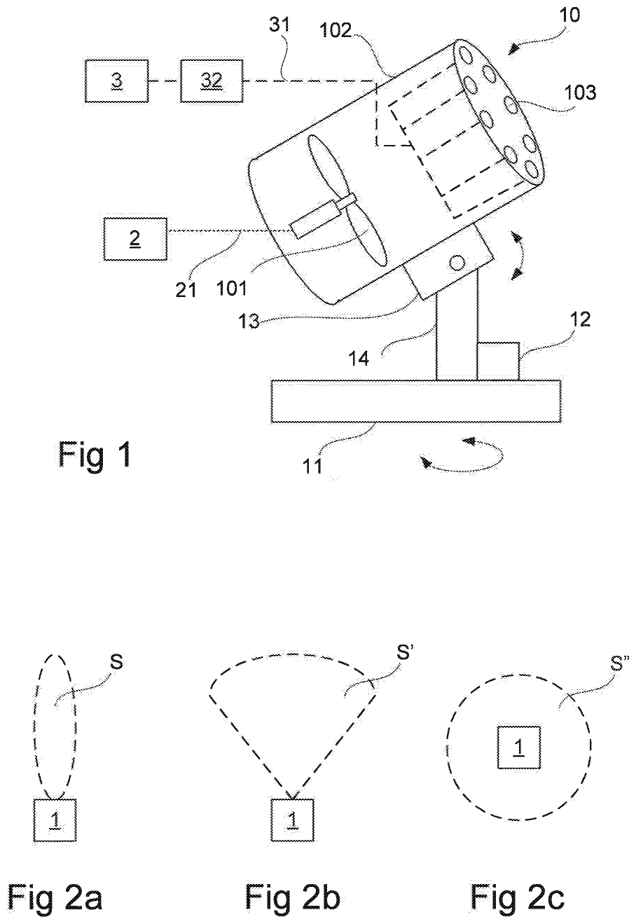

FIG. 1 schematically shows an embodiment of a droplet generating unit 1, which can form part of the system.

The droplet generating unit 1 comprises a frame 11.

The frame 11 may be arranged to support a single mist generator 10.

The frame 11 can be grounded, i.e. be arranged to be placed directly on the ground when using the droplet generating unit 1. The frame 11 may for instance comprise one or more pairs of feet arranged to be placed in forest terrain. In addition or alternatively, the frame 11 may comprise at least one pivot wheel or other non-driven transport wheel, which may be lockable.

The droplet generating unit 1 further comprises a fan driven droplet generator 10 attached to the frame 11.

The fan driven droplet generator 10 may be designed as a type of cannon.

The fan driven droplet generator 10 comprises a fan 101 which is arranged to generate a high-velocity air flow. The fan 101 is arranged to draw air into the fan driven droplet generator 10.

Further, the fan driven droplet generator 10 includes a discharge tube 102 to create a high velocity air flow. The discharge tube can have a decreasing cross-sectional area, which can help to increase the flow rate at the outlet.

Each droplet generator 10 of the system may be configured to provide an air volume flow of 5-60 m³/s, preferably 5-50 m³/s, 5-40 m³/s, 5-30 m³/s, 6-25 m³/s, 6-20 m³/s, 6-15 m³/s or 7-10 m³/s.

The discharge tube 102 of the fan driven droplet generator 10 has a distal end.

Furthermore, the fan driven droplet generator 10 comprises a plurality of nozzles 103, see FIG. 1. Said plurality of nozzles 103 are operatively connected to the liquid source 3.

The purpose of the liquid source 3 is to supply liquid to the fan driven droplet generator 1 and can be different types of liquid sources. The liquid source can be a naturally occurring liquid source, i.e. a liquid source that is not temporarily provided solely for firefighting. The liquid source may, for example, comprise at least one of the following: a sea, a lake, a watercourse, a river, a pond, and/or an open water reservoir.

Alternatively, the liquid source may be a liquid source temporarily arranged for firefighting, for example in the form of a fire pond.

The liquid can be led from the liquid source 3 to the droplet generating unit 1 via one or more liquid lines 31.

The liquid source 3 can thus be separate from the mist generating unit 1 and connected to the mist generating unit 1 via a hose.

The hose can have a length of at least 10 m, preferably at least 20 m.

The system may further comprise a pump 32 for pumping liquid from the liquid source 3 to the droplet generating unit 1 via said one or more liquid lines 31.

The droplet generating unit can be supplied with liquid by connection to a fire hydrant (not shown).

At least some of said droplet generating units may be connected to the same liquid source.

For example, the system may include a pump for pumping liquid from a liquid source to a plurality of droplet generating units via one or more liquid lines.

Alternatively, at least some of said droplet generating units may be connected to different liquid sources.

For example, the system may comprise at least two pumps, each arranged to pump liquid from a respective liquid source to one or more respective mist generating units via one or more liquid lines.

Each droplet generator 10 of the system may be configured to consume water at a rate of 20-100 l/min, preferably 30-90 l/min or 30-70 l/min.

FIG. 1 further shows that the nozzles 103 of the fan driven droplet generator 10 are arranged proximal to the distal end of the discharge tube 102 to create a plurality of liquid droplets.

Each fan driven droplet generator 10 of the system may be configured to provide liquid droplets having an average size of 5-180 micrometers in diameter, preferably 10-150 micrometers, 10-50 micrometers, 50-100 micrometers, about 25 micrometers or about 70 micrometers in diameter.

The liquid droplets in turn form a mist.

At least some of said droplet generators 10 of the system may be configured to operate with a pressure at the nozzles 103 of 70 bar.

Furthermore, each droplet generator 10 of the system is angular adjustable relative to the frame 11 at an angle of 10-60 degrees seen to a horizontal plane, preferably 20-50 degrees seen to a horizontal plane.

For example, each droplet generating unit 1 may comprise an angle actuator 13, wherein the angle actuator 13 is configured to angle the droplet generator 10 at an angle of 10-60 degrees seen to a horizontal plane, preferably 20-50 degrees seen to a horizontal plane.

FIG. 1 shows a droplet generator 10, wherein the frame 11 comprises an angle actuator 13.

At least some of said droplet generating units 1 of the system may further comprise a pivotable attachment portion 14, whereby the droplet generating 10 is rotatable relative to the frame 11 about a vertical axis.

At least some of said droplet generating units 1 of the system may further comprise a rotation actuator 12. The rotation actuator 12 may be configured to rotate the droplet generator 10 relative to the frame 11 about a vertical axis.

Thus, at least some of said droplet generators 10 can be rotatable in 360° about a vertical axis.

FIG. 1 shows a droplet generator 10, wherein the frame 11 comprises a pivotable attachment portion 14 and a rotation actuator 12.

A control unit (not shown) may be arranged to control the fan, water supply and any rotary actuators or angle actuators.

FIG. 1 also shows that the system may comprise a power source 2 arranged to supply the plurality of droplet generating units 1 with energy. A line 21 may be provided, for example, which connects the fan 101 to the power source 2 to drive the fan 101.

Furthermore, each droplet generating unit 1 of the system is configured to provide a mist throw length L of 20-200 m, preferably 20-30 m, 30-40 m, 40-50 m, 50-60 m, 60-70 m, 70-80 m. 80-90 m, 90-100 m, 100-120 m, 120-140 m, 140-160 m or 160-180 m.

Each droplet generating unit 1 can be configured to provide a specific spray pattern to control the application of the mist to a specific area.

Said droplet generating units 1 can be configured to operate with the same spray pattern, alternatively with different spray patterns. For example, some of said droplet generating units may be configured to operate with one type of spray pattern and some others of said droplet generating units may be configured to operate with another type of spray pattern.

The droplet generating units can, for example, operate in one or more different directions, in one or more different angles, with an oscillating movement, and/or with a rotating movement.

Preferably, each droplet generator 10 may be configured to discharge a mist at an angle of 10-60 degrees, preferably 20-50 degrees, relative to a horizontal plane.

Furthermore, at least some of said droplet generating units 1 of the system may be configured to apply at least 70% of a water volume provided to the droplet generating unit 1 from the liquid source 3 during operation, to a fire limiting area 42 extending over a distance Di, seen in a direction perpendicular to said fire limiting boundary 4, wherein the distance Di corresponds to 50-80% of the throw length L of the droplet generating unit 1, preferably at least 55% of the throw length L of the droplet generating unit 1.

FIGS. 2a-2c schematically show examples of different spray patterns of the droplet generating units.

FIG. 2a shows a droplet generating unit 1 configured to operate directed with a spray pattern S to provide mist over an elongate area. Thus, the spray pattern of the droplet generating unit 1 can be an elliptical shaped spray pattern S.

FIG. 2b shows a droplet generating unit 1 configured to operate directed with a spray pattern S′ to provide mist over a wide area. Thus, the spray pattern of the droplet generating unit 1 can be a fan-shaped spray pattern S′.

FIG. 2c shows a droplet generating unit 1 configured to operate in 360° rotation with a spray pattern S″ to provide mist over an area surrounding the droplet generating unit.

Thus, the spray pattern of the droplet generating unit 1 can be a circular shaped spray pattern S.

Furthermore, the invention comprises a method for limiting the spread of wildfires. A method for limiting the spread of wildfires will hereby be described in relation to FIGS. 3-5.

A method of limiting the spread of wildfires comprises defining a fire limiting boundary 4.

The step of defining a fire limiting boundary 4 may comprise identifying a position for a wildfire, wherein the fire limiting boundary 4 is defined based on said position.

Said fire limiting boundary can be defined as an elongated line (see FIG. 3) which extends over a length of more than 300 m, preferably more than 1000 m, or more than 5000 m.

In addition or alternatively, said fire limiting boundary 4 can be defined by extending along at least a part of a property boundary 61 (see FIG. 4). The property boundary 6 surrounds a property 6, for example a property or a country estate.

In addition or alternatively, said fire limiting boundary 4 may extend along a forest road or a powerline corridor (not shown).

The method further comprises positioning a plurality of droplet generating units 1 along the fire limiting boundary 4.

The droplet generating units can be designed as described above.

The method may comprise positioning at least two droplet generating units 1 per 100 m of a length of said fire limiting boundary 4.

The step of positioning a plurality of mist generating units along the fire limiting boundary 4 may comprise moving the mist generating units 1 from at least one central supply location (not shown) accommodating at least some of said plurality of mist generating units 1 to positions along the fire limiting boundary 4.

The method may, for example, comprise that the mist generating units 1 are moved by means of a transport vehicle (not shown) and unloaded from the transport vehicle at the respective said position.

The method further comprises connecting said droplet generating units 1 to a liquid source 3.

The method further comprises activating said droplet generating units 1 so that a mist is applied to a border area 41 (see FIGS. 3 and 4) along said fire limiting boundary 4.

Said border area (41) has a width, seen in a direction across the fire limiting boundary, which is 20-200 m, preferably 50-150 m.

Said initiation of said droplet generating units 1 is initiated before a distance Df (see FIG. 3) from the fire limiting boundary 4 to a wildfire 5 is at least 500 m, preferably at least 1000 m, at least 2000 m, at least 5000 m, or at least 10,000 meters.

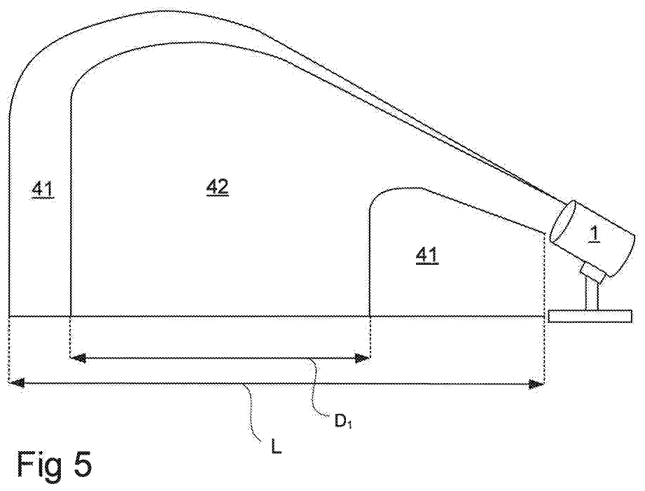

Furthermore, the method may comprise applying at least 70% of a water volume supplied to the droplet generating unit 1 from the liquid source 3 to a fire limiting area 42 extending over a distance Di, seen in a direction perpendicular to said fire limiting boundary 4, wherein the distance Di corresponds to 50-80% of the throw length L of the droplet generating unit 1, preferably at least 55% of the throw length L of the droplet generating unit (see FIG. 5).

The fire limiting area 42 is located within the border area 41.

Said initiation of said droplet generating units 1 can be initiated when a wildfire 5 is at least 3 hours away, or preferably at least 5 hours away, given an expected spread rate of said wildfire 5.

An average moisture ratio of a forest fuel within the fire limiting border area 42 may be at least 25% measured at a time 5 hours after said actuation of said droplet generating units 1 is initiated, preferably measured at a time 3 h after said actuation of said droplet generating units 1 is initiated.

Furthermore, the method may comprise that each droplet generator 10, when in operation, discharges a mist at an angle of 10-60 degrees, preferably at an angle of 20-50 degrees, relative to a horizontal plane.

Furthermore, the method may comprise that at least some of said droplet generators 10, when in operation, are actuated to rotate relative to the frame 11 about a vertical axis.

The rotation can be 300-360 degrees or 90-180 degrees.

The rotation can be driven.

Furthermore, the method may comprise that at least some of said droplet generating units operate with an oscillating movement.

Furthermore, the method may comprise that at least some of said droplet generating units operate with different types of spray patterns during different time phases of application of the mist.

The method may comprise, for example, that at least some of said droplet generating units operate with a first type of spray pattern S1 in an initial phase of application of the mist and with a second type of spray pattern S2 in a secondary phase of application of the mist, wherein the second type of spray pattern S2 differs from the first type of spray pattern S1.

The method may further comprise applying a third type of spray pattern S3, in a tertiary phase of application of the mist, wherein the third type of spray pattern S3 differs from the first and/or second type of spray pattern S1, S2.

Alternatively, at least some of said droplet generating units may operate alternately between different spray patterns.

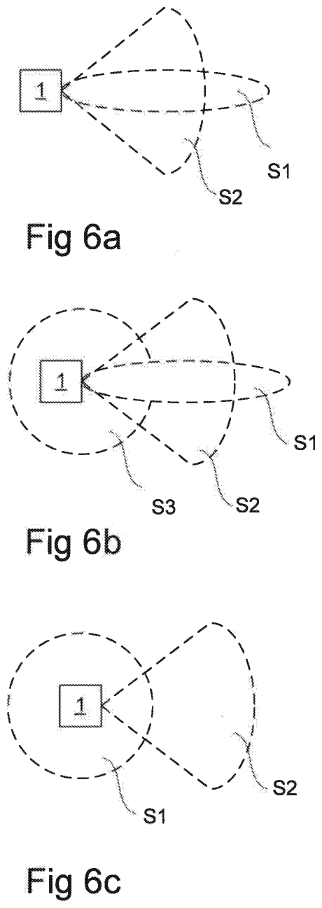

FIGS. 6a-6c show different combinations of spray patterns that can be generated by one and the same droplet generating unit during different phases of application of the mist. However, other combinations are also possible.

According to a first example of the method as described above, droplet generating units with a throw length L of 40 meters and with nozzles consuming 60 liters of water per minute are used.

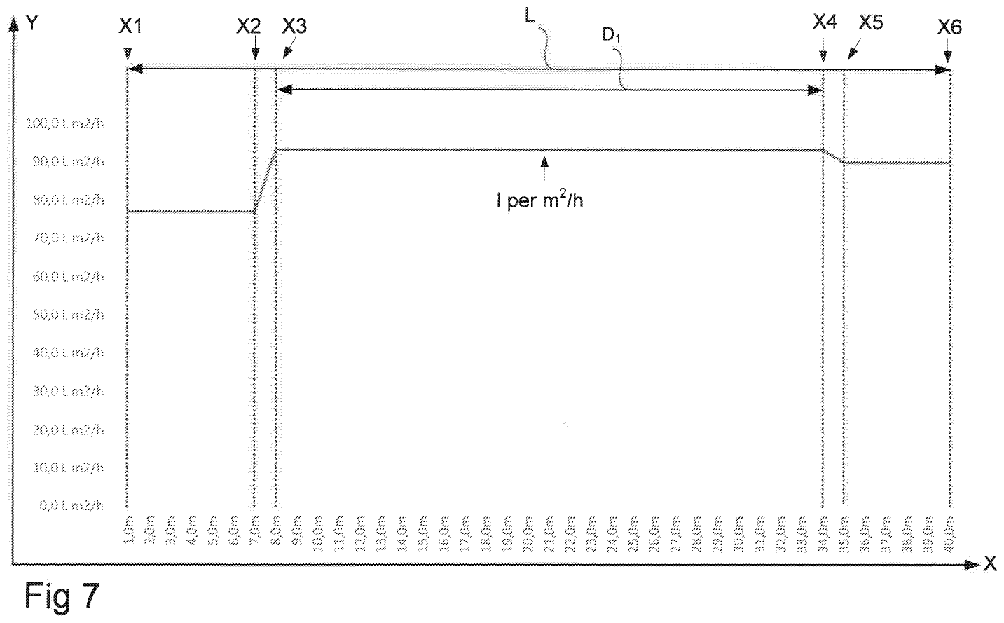

FIG. 7 shows the application of water volume (liters) per area and hour when using a droplet generating unit with a throw length L of 40 meters and with nozzles consuming 60 liters of water per minute.

The Y-axis defines liters of water per m²/h. The X-axis defines the throw length L in meters. Thus, FIG. 7 illustrates a first example of how the amount of water supplied can be distributed over an area given a certain throw length.

According to a second example of the method as described above, droplet generating units with a throw length L of 40 meters and with nozzles consuming 100 liters of water per minute are used.

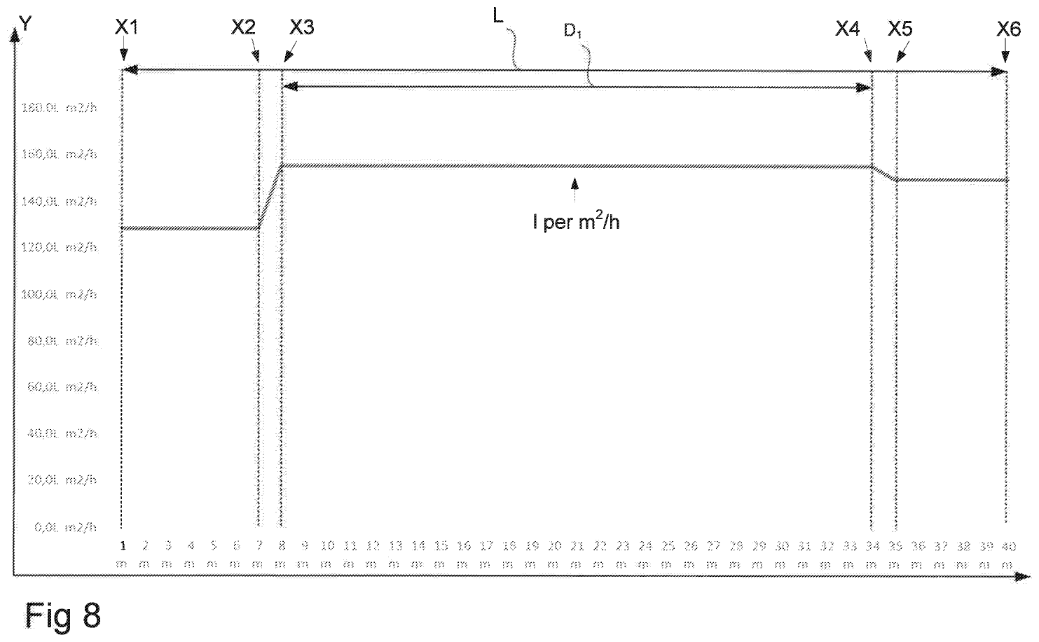

FIG. 8 shows the application of water volume (liters) per area and hour when using a droplet generating unit with a throw length L of 40 meters and with nozzles that consume 100 liters of water per minute.

The Y-axis defines liters of water per m²/h. The X-axis defines the throw length L in meters. Thus, FIG. 8 illustrates a second example of how the amount of water supplied can be distributed over an area given a certain throw length.

The throw length L according to FIGS. 7 and 8 is measured as a distance between the points X1 and X6. X1 defines the position of the droplet generating unit.

As described above, the method may comprise applying a majority of a water volume supplied to the droplet generating unit 1 from the liquid source 3 to a fire limiting area 42 extending over a distance Di, seen in a direction perpendicular to said fire limiting boundary 4. The distance Di according to FIGS. 7 and 8 are measured as a distance between the points X3 and X4.

The water supply speed is the least within an area located closest to the droplet generating unit, which extends from point X1 to point X2 according to FIGS. 7 and 8.

Points X2 and X3 define a stretch of a first transition area, within which the water supply rate (liters per m²/h) increases seen in a direction from X2 to X3 according to FIGS. 7 and 8.

Points X4 and X5 define a stretch of a second transition area, within which the water supply rate (liters per m²/h) decreases seen in a direction from X4 to X5 according to FIG. 7 or 8.

It is understood that said droplet generating units, positioned along the fire limiting boundary, may be configured to operate in substantially the same manner, for example with respect to throw length, angle, direction, movement pattern, spray pattern, droplet size, air volume flow, supplied water volume/min, etc. For example, all droplet generating units may, or at least some of said droplet generating units may be configured to operate substantially in the same manner.

Alternatively, said droplet generating units, positioned along the fire limiting boundary, may be configured to operate in different ways, for example with respect to throw length, angle, direction, movement pattern, spray pattern, droplet size, air volume flow, added water volume/min, etc.

1. A method of limiting spread of a wildfire, comprising:
defining a fire limiting boundary,
positioning a plurality of droplet generating units along the fire limiting boundary,
connecting said droplet generating units to a liquid source, and
activating said droplet generating units so that a mist is applied to a border area along said fire limiting boundary,
wherein said border area has a width, as seen in a direction across the fire limiting boundary, which is 20-200 m,
wherein said actuation of said droplet generating units is initiated before the wildfire is at least 500 m, from the fire limiting boundary,
wherein each of the droplet generating units comprises
a frame, and
a fan driven droplet generator attached to the frame,
wherein the fan driven droplet generator comprises:
a fan for drawing air into the fan driven droplet generator;
a discharge tube for creating a high velocity air flow,
wherein the discharge tube has a distal end; and
a plurality of nozzles that are operatively connected to the liquid source, and which are arranged proximally to the distal end of the discharge tube to create a plurality of liquid droplets to form a mist,
wherein each droplet generating unit provides a mist throw length of 20-200 m, and
wherein each droplet generator operates in an angled position relative to the frame at an angle of 10-60 degrees seen to a horizontal plane.

2. The method according to claim 1, wherein each droplet generator operates to provide an air volume flow of 5-60 m3/s.

3. The method according to claim 1, wherein each droplet generator, when in operation, consumes water at a rate of 20-100 l/min.

4. The method according to claim 1, wherein at least some of said droplet generators, when in operation, operate with a pressure of the nozzles at 70 bar.

5. The method according to claim 1, wherein at least 70% of a water volume supplied to the droplet generating unit from the liquid source is applied to a fire limiting area extending over a distance, as seen in a direction perpendicular to said fire limiting boundary, corresponding to 50-80% of the throw length of the droplet generating unit.

6. (canceled)

7. The method according to claim 1, wherein said actuation of said droplet generating units is initiated when a wildfire is at least 3 hours away, given an expected spread rate of said wildfire.

8. The method according to claim 1, wherein an average moisture ratio of a forest fuel within the fire limiting area is at least 25% measured at a time 5 hours after said actuation of said droplet generating units is initiated.

9. The method according to claim 1, wherein the step of defining a fire limiting boundary comprises identifying a position for a wildfire,
wherein the fire limiting boundary is defined based on said position, and
wherein the step of positioning a plurality of mist generating units along the fire limiting boundary comprises moving the mist generating units from at least one central supply location accommodating at least some of said plurality of mist generating units to positions along the fire limiting boundary.

10. (canceled)

11. The method according to claim 1, wherein said fire limiting boundary is defined as an elongated line extending over a length of more than 300 m.

12. The method according to claim 1, wherein the fire limiting boundary extends along a forest road or a powerline corridor.

13. The method according to any claim 1, wherein said fire limiting boundary is defined by extending along at least a part of a property boundary.

14. The method according to any claim 1, wherein at least two droplet generating units are positioned per 100 m of a length of said fire limiting boundary.

15. The method according to any claim 1, wherein each fan driven droplet generator produces liquid droplets having an average size of 5-180 micrometers.

16. The method according to claim 1, wherein at least some of said droplet generators are actuated to rotate relative to the frame about a vertical axis.

17. The method according to claim 1, wherein at least some of said droplet generators are actuated to operate with an oscillating movement.

18. The method according to claim 1, wherein at least some of said droplet generating units are actuated to operate with a first type of spray pattern S1 during a first time period, and with a second type of spray pattern S2 during a second time period.

19. The method according claim 1, wherein at least some of said droplet generating units are actuated to operate alternately between at least two different types of spray patterns.

20. A system for limiting the spread of wildfires, comprising:
a plurality of droplet generating units, positioned along a fire limiting boundary, and
a liquid source,
wherein each droplet generating unit comprises
a frame, and a fan driven droplet generator attached to the frame,
wherein the fan driven droplet generator comprises:
a fan for drawing air into the fan driven droplet generator;
a discharge tube for creating a high velocity air flow,
wherein the discharge tube has a distal end; and
a plurality of nozzles that are operatively connected to the liquid source, and which are arranged proximally to the distal end of the discharge tube to create a plurality of liquid droplets to form a mist,
wherein each droplet generating unit is configured to provide a mist throw length of 20-200 m, and
wherein each droplet generator is angular adjustable relative to the frame at an angle of 10-60 degrees seen to a horizontal plane.

21. (canceled)

22. The system according to claim 20, wherein the liquid source is separate from the mist generating unit and connected to the mist generating unit via a hose.

23. The system according to claim 20, wherein the liquid source comprises at least one of the following: a sea, a lake, a watercourse, a river, a pond, and/or an open water reservoir.

24-34. (canceled)
